(19) United States
(12) Patent Application Publication
(10) Pub. No.: US 2009/0109380 A1
(43) Pub. Date: Apr. 30, 2009

(54) LIQUID CRYSTAL DISPLAY DEVICE

(76) Inventor: Hiroyuki Kamee, Kanagawa (JP)

Correspondence Address: NIXON & VANDERHYE, PC, 901 NORTH GLEBE ROAD, 11TH FLOOR, ARLINGTON, VA, 22203, US

(21) Appl. No.: 12/301,519

(22) PCT Filed: May 21, 2007
(86) PCT No.: PCT/JP2007/060386

§ 371 Date: Nov. 19, 2008

(30) Foreign Application Priority Data
Jun. 2, 2006 (JP) 2006-154959

(51) Int. Cl. G02F 1/1335

(52) U.S. Cl. 349/96; 349/106

(57) ABSTRACT

The present invention provides a liquid crystal display device which can provide sufficient contrast. The liquid crystal display device of the present invention is a liquid crystal display device having a structure in which a liquid crystal layer is interposed between a rear substrate and a front substrate, wherein the liquid crystal display device includes a first polarizing layer between the rear substrate and the liquid crystal layer, and the first polarizing layer is arranged between the liquid crystal layer and a depolarization part such as a thin film transistor, a wiring, a color filter, a pixel electrode, and a structure providing a rear face-side surface of the liquid crystal layer with an irregularity.

### TECHNICAL FIELD

The present invention relates to a liquid crystal display device. More specifically, the present invention relates to a liquid crystal display device preferably used in equipment such as a TV, a display monitor, and a personal digital assistance.

### BACKGROUND ART

A liquid crystal display device takes advantage of its slim profile, lightweight, and low power consumption to have been used in various fields. A liquid crystal display device which displays color images has been mainly used, currently. For displaying color images, it is essential for the liquid crystal display device to include color filters of a plurality of colors such as red, green, and blue. However, such color filters are commonly known to have a property of reducing a polarization degree of incident light. Accordingly, due to light which has been depolarized by the color filters, a transmittance of light is increased under dark condition. Therefore, performances of the liquid crystal display device are significantly deteriorated, and therefore such a liquid crystal display device cannot provide high contrast.

For this problem, a liquid crystal device including a polarizing layer, wherein the polarizing layer is arranged between a color filter layer and a liquid crystal material layer to compensate depolarization of linear polarized light in the color filter layer (for example, refer to Patent Document 1). According to this, the depolarized light is reduced, which increases a transmittance of light under dark conditions. Therefore, performances of the device can be improved. However, the liquid crystal display device includes various parts which have a property of reducing a polarization degree of incident light, in addition to the color filter layer. Hence, due to light which has been depolarized by such parts, a transmittance of light is increased under dark conditions. Thus, the device still has room for improvement in contrast.

### [Patent Document 1]

Japanese Kokai Publication No. Hei-10-161105

### DISCLOSURE OF INVENTION

The present invention has been made in view of the abovementioned state of the art. The present invention has an object to provide a liquid crystal display device which can provide high contrast.

The present inventors made various investigations on a liquid crystal display device which has a structure in which a liquid crystal layer is interposed between a rear substrate and a front substrate. The inventors noted a part which has a depolarization property and which exists in the liquid crystal display device. The inventors further noted that the liquid crystal display device includes elements such as a thin film transistor (TFT), bus lines such as a scanning line and a signal line, and a pixel electrode, which have a depolarization property, in addition to the color filter. Surface irregularities or edges of these components scatter light. Therefore, even if a polarizing layer is arranged outside (on the rear face side) of the rear substrate to cause polarized light to enter a liquid crystal layer, part of the polarized light is depolarized by these scattering factors, and the light which has been partly depolarized is caused to enter the liquid crystal layer. As a result, the contrast is reduced.

FIG. 18 is a planar view schematically showing one pixel of a TFT array substrate constituting a conventional liquid crystal display device in Vertical Alignment (VA) mode. FIG. 3 is a schematic cross-sectional view taken along line A-B in FIG. 18.

Various structures have been disclosed as a structure of the conventional liquid crystal display device in VA mode. For example, as shown in FIG. 18, in order for a display device to provide uniform display when being viewed in any directions, a pixel electrode 9 is provided with a slit (slit part) 9a to generate an inclined electric field near the slit part 9a, thereby specifying a direction where liquid crystal molecules in a liquid crystal layer 300 are inclined, or a dielectric structure having an inclined surface is formed on the pixel electrode 9, thereby specifying the direction where the liquid crystal molecules in the liquid crystal layer 300 are inclined, starting from the dielectric structure. Thus, the VA mode in which the liquid crystal molecules in one pixel are inclined to plural directions (multi-domain) is particularly referred to as Multi-domain Vertical Alignment (MVA) mode.

FIG. 19 (a) is a planar view schematically showing one pixel of a TFT array substrate constituting a conventional liquid crystal display device in In-Plane Switching (IPS) mode. FIG. 19(b) is a schematic cross-sectional view taken along line A-B in FIG. 19(a).

According to the liquid crystal display device in IPS mode, electrodes are formed on only one substrate surface to generate a parallel electric field (lateral electric field), as shown in FIGS. 19(a) and (b). These electrodes have a structure in which comb teeth are arranged to face each other (so-called comb teeth-like electrode).

FIG. 20(a) is a cross-sectional view schematically showing a liquid crystal display device in Super-IPS mode, which is an application of the conventional IPS mode. FIG. 20(b) is a schematic cross-sectional view taken along line A-B in FIG. 20(a).

As shown in FIGS. 20(a) and 20(b), the liquid crystal display device in Super-IPS mode has an electrode structure in which the comb teeth are bent like a dog leg, thereby introducing a sub-pixel in order to suppress color change in every azimuth.

Then, the inventors found the followings. Among various display modes of the liquid crystal display device, particularly according to the VA mode, the liquid crystal molecules are completely vertically aligned under no voltage state, and light which has been polarized passes through the liquid crystal layer without being influenced by the liquid crystal molecules, and the light is completely shielded by a polarizer on the front face side. Therefore, the liquid crystal display device in VA mode can provide high contrast. However, the liquid crystal display device in VA mode generally adopts the above-mentioned electrode structure in order to provide a wider viewing angle. Therefore, many scattering factors depolarize part of the polarized light, and as a result, the high contrast performances which the device in VA mode can originally exhibit cannot be sufficiently exhibited.

For this problem, a method in which a shielding layer is arranged above or below these scattering factors is mentioned. However, if every scattering factor is shielded, the aperture ratio is decreased. In addition, in some display modes which have been commonly adopted for mass-produced devices, as shown in FIG. 18, the pixel electrode 9 is provided with the slit part 9a, or as shown in FIGS. 19(a) and 19(b) and FIGS. 20(a) and 20(b) , the pixel electrode 9 is formed to have a comb teeth shape. Therefore, in such devices, a part which cannot be shielded tends to depolarize the polarized light. Then, the inventors found the followings. The first polarizing layer is arranged between a rear substrate and a liquid crystal layer, and thereby light which has passed through the rear substrate can be polarized near the liquid crystal layer. As a result, the light with a high polarization degree can be caused to enter the liquid crystal layer. Accordingly, the contrast can be improved without reducing an aperture ratio. Thus, the above-mentioned problems had been admirably solved, leading to completion of the present invention.

That is, the present invention is a liquid crystal display device having a structure in which a liquid crystal layer is interposed between a rear substrate and a front substrate, wherein the liquid crystal display device includes a first polarizing layer between the rear substrate and the liquid crystal layer.

The present invention is mentioned below in more detail.

The liquid crystal display device of the present invention has a structure in which the liquid crystal layer is interposed between the rear substrate and the front substrate. The rear substrate is a substrate which is arranged on the rear face side of the liquid crystal layer. The front substrate is a substrate which is arranged on the front face side (observation face side) of the liquid crystal layer. The rear and front substrates are not especially limited. Insulating substrates such as a glass substrate and a plastic substrate are mentioned, for example. The liquid crystal layer may be composed of only liquid crystal molecules, or may include other components.

The above-mentioned liquid crystal display device includes the first polarizing layer between the rear substrate and the liquid crystal layer. According to this, in comparison to an embodiment in which a polarizing layer is arranged only on the rear face side of the rear substrate, the polarizing layer is arranged closer to the liquid crystal layer and light with a high polarization degree can be caused to enter the liquid crystal layer. As a result, the contrast can be improved. In addition, the contrast can be improved without reducing the aperture ratio, which is different from the case where the light-shielding layer is formed above or below the scattering factor.

The above-mentioned first polarizing layer is not especially limited as long as it can convert natural light into polarized light such as linear polarized light (plane-polarized light), circular polarized light, and elliptical polarized light. The first polarizing layer may be arranged in different layer levels or may be arranged to be separated in a plurality of regions in the same layer level. The first polarizing layer may have a single or multilayer structure. If the first polarizing layer has a multilayer structure, the respective layers maybe stacked continuously, or may be stacked with another member therebetween.

The following methods (1) to (3) may be mentioned as a method of forming the first polarizing layer, for example. (1) a method in which an alignment film is formed, and a liquid containing dichroism pigment molecules is applied on the alignment film by a coating method which generates a shearing flow, and thereby the dichroism pigment molecules are aligned, and then, the liquid is dried; (2) a method in which a liquid containing dichroism pigment is applied by a spin coat method, a printing method, and the like, to form a molecular coating, and then the coating is exposed with linear polarized light and the like, thereby aligning the dichroism pigment to one direction; and (3) a method in which a polarizing layer is previously prepared on another substrate using the above-mentioned methods (1) and (2), and the polarizing layer is re-formed on a target substrate through a transfer process. Dye molecules such as an azo dye and a polyiodine compound salt are preferable as the above-mentioned pigment molecules of the molecular coating.

The liquid crystal display device of the present invention is not especially limited, and it may or may not include other components as long as it includes the above-mentioned rear substrate, liquid crystal layer, front substrate, and the first polarizing layer. For example, the above-mentioned liquid crystal display device may include a thin film transistor, bus lines such as a scanning line and a signal liner a resin layer, and an alignment film, between the rear substrate and the liquid crystal layer. Between the liquid crystal layer and the front substrate, the device may include an alignment film, a counter electrode, and a color filter, for example. The display mode of the liquid crystal display device is not especially limited, and VA mode, IPS mode, OCB (Optically Compensated Birefringence) mode and the like are mentioned. It is preferable that the liquid crystal display device is in accordance with VA mode in order to provide high contrast.

Preferable embodiments of the liquid crystal display device of the present invention are mentioned below in more detail.

The above-mentioned liquid crystal display device may not include a polarizing layer on a rear face side of the rear substrate. However, it is preferable that the liquid crystal display device includes a polarizing layer (hereinafter, also referred to as “the second polarizing layer”) on a rear face side of the rear substrate. According to this, the first polarizing layer can increase again a polarization degree of light which has been polarized by the second polarizing layer and then depolarized by the scattering factor. Therefore, light with a higher polarization degree can be caused to enter the liquid crystal layer. As a result, the contrast can be more improved.

The above-mentioned second polarizing layer is normally arranged in such a way that a transmission axis of the second polarizing layer is substantially parallel to (parallel Nicol) a transmission axis of the first polarizing layer. If linear polarized light is caused to enter the liquid crystal layer, for example, it is preferable that both of the first and second polarizing layers are linear polarizers, and the transmission axes of the both linear polarizers are substantially parallel to each other. If circular or elliptical polarized light is caused to enter the liquid crystal layer, it is preferable that the first polarizing layer is a circular or elliptical polarizer (a polarizer having a structure in which a linear polarizer (on the rear face side) and a retardation film (on the front face side) are stacked), and the second polarizing layer is a linear polarizer, and the transmission axes of the both linear polarizers are substantially parallel to each other. The arrangement embodiment of the second polarizing layer is not especially limited. The second polarizing layer may be attached to the rear substrate, or may be arranged as a member constituting a polarizing plate and this polarizing plate may be attached to the rear substrate. The material for the second polarizing layer may be the same as or different from that for the first polarizing layer.

It is preferable that liquid crystal display device includes a depolarization part between the rear substrate and the liquid crystal layer, and the first polarizing layer is arranged between the depolarization part and the liquid crystal layer. According to this, if the polarizing layer (the second polarizing layer) is not arranged on the rear face side of the rear substrate, incident light can be polarized between the depolarization part and the liquid crystal layer. If the polarizing layer (the second polarizing layer) is arranged on the rear face side of the rear substrate, the first polarizing layer can increase again a polarization degree of light which has been polarized by the second polarizing layer and then depolarized by the depolarization part. Accordingly, light with a higher polarization degree can be caused to enter the liquid crystal layer. As a result, the contrast can be further improved.

The term “depolarization part” in this description means a part which causes depolarization (scattering factor), and preferably means a part which has a scattering degree of 0.001% or more. The scattering degree of the depolarization part is determined as follows. A completely polarized light is caused to enter the depolarization part, and light which has outputted from the depolarization part is measured for a polarization state. This polarized light is decomposed into two components: a component parallel to a polarization axis of the incident light; and a component perpendicular to the polarization axis of the incident light. Then, the proportion of the perpendicular component relative to the incident light is the scattering degree. The part having a scattering degree of 0.001% means a scattering factor where 99.999% of light relative to an intensity of incident light passes through the part while maintaining its polarization state, and 0.001% of light is converted into a component perpendicular to the polarization direction of the incident light. If such a scattering factor is arranged between a pair of polarizing layers which gives a contrast (parallel transmittance/perpendicular transmittance) of 10000, the contrast is reduced to 9000. If the above-mentioned liquid crystal display device includes a plurality of depolarization parts between the rear substrate and the liquid crystal layer, the first polarizing layer is arranged between at least one depolarization part and the liquid crystal layer. It is preferable that the first polarizing layer is arranged between the liquid crystal layer and every depolarization part which has a scattering degree of 0.001% or more.

It is preferable that the depolarization part is at least one selected from the group consisting of a transistor, a wiring, a color filter, a pixel electrode, and a structure providing a rear face-side surface of the liquid crystal layer with an irregularity. If the first polarizing layer is arranged between the liquid crystal layer and the transistor or the wiring, the reduction in contrast, due to light scattering by surface irregularities or end parts (edges) of the transistor and the wiring, can be suppressed. In addition, if the first polarizing layer is arranged between the liquid crystal layer and the color filter, scattering due to a pigment of the color filter can be compensated. As a result, the contrast can be improved. If the color filter is arranged on the rear face side of the liquid crystal layer, a reduction in aperture ratio, due to misalignment between the color filter and the pixel electrode, can be also suppressed. Further, if the first polarizing layer is arranged between the liquid crystal layer and the pixel electrode, surface irregularities or end parts (edges) of the pixel electrode are covered, and light scattering due to the surface irregularities or end parts (edges) of the pixel electrode can be suppressed. As a result, a reduction in contrast can be suppressed. In addition, if the first polarizing layer is arranged between the liquid crystal layer and the structure which provides the rear face-side surface of the liquid crystal layer with an irregularity, a reduction in contrast, due to light scattering by this structure, can be suppressed.

A thin film transistor (TFT) which is used for driving a pixel electrode, and the like, is mentioned as the above-mentioned transistor. Examples of the wiring include bus lines such as a scanning line and a signal line. Examples of the material for the wiring include metals such as tantalum nitride and tantalum. The term “color filter” in this description means a filter which selectively transmits light in a specific wavelength region. The material for the color filter is not especially limited and examples thereof include a resin which has been stained by a dye, a resin into which a pigment has been dispersed, a material obtained by solidifying a fluid material (ink) into which a pigment has been dispersed. The method of forming the color filter is not especially limited and examples thereof include a dyeing method, a pigment dispersion method, an electrode position method, a printing method, an ink-jet method, a color resist method (also referred to as a “transfer method”, “dry film laminate (DFL) method”, or “dry film resist method”). Examples of the material for the pixel electrode include indium tin oxide (ITO) and indium zinc oxide (IZO) . The pixel electrode may have a slit part or may be formed into a comb teeth shape. A dielectric structure which specifies a direction where the liquid crystal molecules in the liquid crystal layer are inclined, and the like, may be mentioned as the structure which provides the rear face-side surface of the liquid crystal layer with an irregularity. A dielectric material such as an acrylic resin may be mentioned as the material for this structure. A slit coat method and the like may be mentioned as a method of forming this structure, and further, a photolithography method and the like may be mentioned as a patterning method. The following embodiments are preferable embodiments of the above-mentioned liquid crystal display device. (1) an embodiment in which the first polarizing layer is arranged between the liquid crystal layer, and the transistor, the wiring, and the pixel electrode; (2) an embodiment in which the first polarizing layer is arranged between the liquid crystal layer, and the transistor, the wiring, the pixel electrode, and the structure which provides the rear face-side surface of the liquid crystal layer with an irregularity; (3) an embodiment in which the first polarizing layer is arranged between the liquid crystal layer, and the transistor, the wiring, the color filter, and the pixel electrode; and (4) an embodiment in which the first polarizing layer is arranged between the liquid crystal layer, and the transistor, the wiring, the color filter, the pixel electrode, and the structure which provides the rear face-side surface of the liquid crystal layer with an irregularity.

It is preferable that the first polarizing layer is selectively arranged at the depolarization part. According to this, the first polarizing layer is partly formed only at a part which needs polarization compensation. Therefore, a reduction in transmittance of white state can be suppressed. An embodiment in which the first polarizing layer is arranged only at an end part (edge) of the wiring, and an embodiment in which the first polarizing layer is arranged only at an end part (edge) of the pixel electrode are mentioned as such an embodiment. According to the embodiment in which the first polarizing layer is arranged only at an end part (edge) of the pixel electrode, for example, a voltage which is applied to the pixel electrode can be applied to the liquid crystal layer, almost as it is. As a result, the device can be driven at a lower voltage, in comparison to an embodiment in which the first polarizing layer is arranged over the entire pixel electrode surface.

It is preferable that the liquid crystal display device includes a pixel electrode between the rear substrate and the liquid crystal layer, and the first polarizing layer is arranged on a rear face side of the pixel electrode. According to this, a voltage which is applied to the pixel electrode can be applied to the liquid crystal layer, as it is. Therefore, the device can be driven at a lower voltage, in comparison to an embodiment in which the first polarizing layer is arranged on the pixel electrode. In this case, it is preferable that the pixel electrode has a scattering degree of less than 0.001. If the pixel electrode has a scattering degree of 0.001% or more, a degree of light scattering by the pixel electrode is large, which might remarkably reduce the contrast.

It is preferable that the liquid crystal display device includes a protection layer between the first polarizing layer and the liquid crystal layer. If the protection layer is arranged between the liquid crystal layer and the first polarizing layer, elution of ionic substances which might exist inside the first polarizing layer into the liquid crystal layer can be prevented, which can increase the reliability. The protection layer may or may not be in contact with the first polarizing layer, but preferably in contact with the first polarizing layer in order to further improve the reliability. A transparent polymer is preferable as the material for the protection layer. A transparent acrylic resin and the like may be mentioned. As a method of forming the protection layer, a method in which a solution of a thermosetting monomer is applied by a slit coat method, and then polymerized by evaporating the solvent by heat.

It is preferable that the liquid crystal display device includes a third polarizing layer between the liquid crystal layer and the front substrate. According to this, light which has been outputted from the liquid crystal layer can be selected by the third polarizing layer at a position near the liquid crystal layer. As a result, the contrast can be further improved. The third polarizing layer and the first polarizing layer are in a parallel Nicol or cross Nicol relationship, but preferably in a cross Nicol relationship in view of the contrast.

It is preferable that the liquid crystal display device includes a fourth polarizing layer on a front face side of the front substrate. According to this, the contrast can be further improved. The fourth polarizing layer is normally arranged in such a way that a transmission axis of the fourth polarizing layer is substantially parallel to (parallel Nicol) the transmission axis of the third polarizing layer. For example, if linear polarized light is outputted from the liquid crystal layer, it is preferable that both of the third and fourth polarizing layers are linear polarizers, and the transmission axes of the both linear polarizers are substantially parallel to each other. If circular or elliptical polarized light is outputted from the liquid crystal layer, the third polarizing layer is a circular or elliptical polarizer (a polarizer having a structure in which a linear polarizer (on the front face side) and a retardation film (on the rear face side) are stacked), and the fourth polarizing layer is a linear polarizer, and the transmission axes of the both linear polarizers are parallel to each other. The arrangement embodiment of the fourth polarizing layer is not especially limited. The fourth polarizing layer may be attached to the front substrate, or may be arranged as a member constituting a polarizing plate and this polarizing plate may be attached to the rear substrate. The material for the fourth polarizing layer may be the same as or different from the material for the third polarizing layer.

It is preferable that the liquid crystal display device includes a depolarization part between the liquid crystal layer and the front substrate, and the third polarizing layer is arranged between the depolarization part and the liquid crystal layer. According to this, the polarized light which has been outputted from the liquid crystal layer can pass through the third polarizing layer before being depolarized by the depolarization part. As a result, the contrast can be further improved.

It is preferable that the depolarization part is at least one selected from the group consisting of a color filter, a common electrode, and a structure which provides a front face-side surface of the liquid crystal layer with an irregularity. If the third polarizing layer is arranged between the liquid crystal layer and the color filter, the common electrode, and the like, light which has been outputted from the liquid crystal layer can be selected before the end parts (edges) of the color filter or the common electrode causes light scattering. As a result, a reduction of contrast ratio can be suppressed.

It is preferable that the liquid crystal display device includes a protection layer between the third polarizing layer and the liquid crystal layer. If the protection layer is arranged between the liquid crystal layer and the third polarizing layer, elution of ionic substances which might exist inside the third polarizing layer into the liquid crystal layer can be prevented, which can increase the reliability.

It is preferable that the third polarizing layer is selectively arranged at the depolarization part. According to this, the third polarizing layer is partly formed only at a part where the polarization needs to be selectively performed. Therefore, a reduction in transmittance of white state can be suppressed. An embodiment in which the third polarizing layer is arranged only at an end part (edge) of the common electrode is mentioned as such an embodiment. According to the embodiment in which the third polarizing layer is arranged only at the end part (edge) of the common electrode, for example, a voltage which is applied to the pixel electrode can be applied to the liquid crystal layer, almost as it is. As a result, the device can be driven at a lower voltage, in comparison to an embodiment in which the third polarizing layer is arranged over the entire common electrode surface.

### EFFECT OF THE INVENTION

According to the liquid crystal display device of the present invention, light with a high polarization degree can be caused to enter the liquid crystal layer. As a result, the contrast can be improved.

### BEST MODES FOR CARRYING OUT THE INVENTION

The present invention is mentioned in more detail below with reference to Embodiments, but not limited to only these Embodiments. Configurations, measurement values, and the like in the following Embodiments are based on simulations which were performed using computer programs.

### Embodiment 1

FIG. 1 is a cross-sectional view schematically showing a liquid crystal display device in accordance with Embodiment 1 of the present invention.

The liquid crystal display device in accordance with the present Embodiment has a structure, as shown in FIG. 1, in which a thin film transistor (TFT) substrate 100 and a counter substrate 200 are arranged with a certain distance therebetween to be parallel to each other due to a sphere or columnar spacer (not shown), and a liquid crystal layer 300 is interposed between the two substrates 100 and 200.

A material with a negative dielectric anisotropy (a dielectric constant ε _{⊥} in a short axis direction of a liquid crystal molecule > a dielectric constant ε _{//} in a long axis direction of a liquid crystal molecule) is used as a liquid crystal material for constituting the liquid crystal layer 300. A vertical alignment film is used as alignment films 13 and 23. A pixel electrode 9 in the TFT substrate 100 is provided with a slit part 9a. Thus, the liquid crystal display device is in accordance with Multi-domain Vertical Alignment mode, which is an application of VA mode. The pixel electrode 9 is provided with the slit part 9a, and thereby an inclined electric field is generated near the slit part 9a to incline liquid crystal molecules in the liquid crystal layer 300 to plural direction within one pixel. As a result, the device can provide uniform display when being viewed in any directions. The display device in the present Embodiment is in accordance with MVA mode, but is not limited thereto. That is, the present invention provides a high effect when it is applied to a mode where many scattering factors are arranged, such as MVA mode and IPS mode, but the made is not limited. The present invention can be preferably applied to any display modes. A TFT 8 which is formed in the TFT substrate 100 is arranged in each pixel and has a function of retaining a charge which is inputted from a source bus line 6.

A color filter 21 which is formed in the counter substrate 200 includes, in each pixel, red (R), green (G), and blue (B) color materials formed by patterning. The number of the colors is not limited to three, and the kind of the colors is not especially limited to red (R), green (G), and blue (B). On the color filter 21, a transparent common electrode 22 and an alignment film 23 are formed in the entire display region. According to the present Embodiment, the TFT 8 is formed in the TFT substrate 100 that is on the rear face side. The color filter 21 is formed in the counter substrate 200 that is on the observer side. However, the arrangement is not limited thereto.

According to the present invention, the first polarizing layer 18a is arranged between the pixel electrode 9 in the TFT substrate 100 and the liquid crystal layer 300. The first polarizing layer 18a has a transmittance for unpolarized light (Y value) of 45% and a contrast of 100.

The contrast of the polarizing layer is measured using an ultraviolet and visible spectrophotometer (product of JASCO Corporation, trade name: VR560). One transparent glass is used as a reference, and a polarizing layer that is a measurement object is attached to each surface of the transparent glass in such a way that polarization axes of the layers are parallel to each other. The transmittance under such a condition is defined as a parallel transmittance (Y value). Further, the polarizing layers are attached in such a way that the polarization axes are perpendicular to each other. The transmittance under such an arrangement is defined as a perpendicular transmittance (Y value). The ratio between the two is the contrast (refer to the following formula (1)).

Contrast of polarizing layer=Parallel transmittance of polarizing layer/Perpendicular transmittance of polarizing layer (1)

With regard to optical performances of the respective polarizing layers, two parameters: k1 (transmittance in the transmission axis direction); and k2 (transmittance in the absorption axis direction), are actually measured and used for simulations.

A scattering degree a of a scatterer existing in a liquid crystal display device 500 is measured by a method shown in FIG. 2. First, completely polarized light 50 is caused to enter the scatterer, and light 51 which has been outputted from the scatterer is measured for its polarization state. Then, this polarized light is decomposed into two components: a component parallel to the polarization axis of the incident light (parallel component) 52; and a component perpendicular thereto (perpendicular component) 53. The proportion of an intensity of the perpendicular component 53 relative to an intensity of the incident light is defined as a. This parameter a is used for simulations as a parameter which indicates the scattering degree of the respective scatterers. Each scattering factor was measured for a scattering degree, and the following results were obtained. The pixel electrode 9 had a scattering degree of 0.015%. The TFT 8 and the wiring 6 could not be independently measured for a scattering degree. Therefore, they were together measured for the scattering degree to give 0.006%. Then, the below-mentioned dielectric structures 15 and 25 which are called rib or rivet had a scattering degree of 0.014%. The color filter 21 had a scattering degree of 0.012%.

According to the present Embodiment, a polarizing layer with low polarization performances, which has a contrast of 100, is used as the first polarizing layer 18a. Therefore, the second polarizing layer 18b is attached to the rear face side of the glass substrate (rear substrate) 10 in such a way that a polarization axis of the second polarizing layer 18b and that of the first polarizing layer 18a are parallel to each other (parallel Nicol). With regard to the polarization performances, the second polarizing layer 18b has a transmittance for unpolarized light of 43% (Y value) and a contrast of 8000. Further, the fourth polarizing layer 18d is attached to the observation side (the front face side) of the glass substrate (the front substrate) 20 that is in the counter substrate 200 in such a way that a polarization axis of the fourth polarizing layer 18d and that of the second polarizing layer 18b are perpendicular to each other (cross Nicol). The fourth polarizing layer 18d has a transmittance for unpolarized light of 43% (Y value) and a contrast of 8000.

According to the present Embodiment, a liquid crystal display device 500 having such a configuration was prepared and measured for optical performances with a ultraviolet and visible spectrophotometer (product of JASCO Corporation, trade name: VR-560). Spectral transmittances (Y values) of white state and black state of the panel were measured. The ratio between the two values is defined as a contrast of the display device (refer to the following formula (2)).

Contrast of display device=Transmittance of white state/Transmittance of black state (2)

As a result, a contrast of the display device in the present Embodiment was 4176, as shown in Table 1.

TABLE 1

| | | Comparative | | | Comparative |
|---|---|---|---|---|---|
| | Embodiment 1 | Embodiment 1 | Embodiment 2 | Embodiment 3 | Embodiment 2 |
| Contrast of display device | 4176 | 1527 | 17853 | 8464 | 2120 |

### Comparative Embodiment 1

FIG. 3 is a cross-sectional view schematically showing a liquid crystal display device in accordance with Comparative Embodiment 1.

The liquid crystal display device in the present Comparative Embodiment is the same as in Embodiment 1, except that the first polarizing layer 18a is not arranged in the TFT substrate 100, as shown in FIG. 3. As a result, the contrast of the display device in Comparative Embodiment 1 was 1527, as shown in Table 1.

This proves that the contrast of the liquid crystal display device in Embodiment 1 is substantially 2.7 times higher than that of the liquid crystal display device in Comparative Embodiment 1. The reason why the liquid crystal display device in Embodiment 1 shows a contrast effect higher than that of the liquid crystal display device in Comparative Embodiment 1 is as follows. That is, according to Comparative Embodiment 1, light which has been polarized by the second polarizing layer 18b is depolarized by the scattering factors such as the source bus line 6, the TFT 8, and the pixel electrode 9 in the TFT substrate 200, and such light with a low polarization degree is caused to enter the liquid crystal layer 300. In contrast, according to Embodiment 1, even if the light is depolarized by the scattering factors in the TFT substrate 200, the first polarizing layer 18a increases the polarization degree of the light again, and such light with a high polarization degree is caused to enter the liquid crystal layer 300.

### Embodiment 2

FIG. 4 is a cross-sectional view schematically showing a liquid crystal display device in accordance with Embodiment 2 of the present invention.

As shown in FIG. 4, the liquid crystal display device in accordance with the present Embodiment has a configuration in which the first polarizing layer 18a is arranged between the liquid crystal layer 300 and the pixel electrode 9 in the TFT substrate 100, and the third polarizing layer 18c is arranged between the color filter 21 and the common electrode 22 in the counter substrate 200. With regard to optical performances of both of these polarizing layers 18a and 18c, the transmittance for unpolarized light (Y value) is 45% and the contrast is 100. The second polarizing layer 18b is arranged on the outer side of the glass substrate 10 and the fourth polarizing layer 18d is arranged on the outer side of the glass substrate 20. In the TFT substrate 100, the polarization axis of the first polarizing layer 18a is parallel to that of the second polarizing layer 18b. In the counter substrate 200, the polarization axis of the third polarizing layer 18c is parallel to that of the fourth polarizing layer 18d. In addition, the second polarizing layer 18b and the fourth polarizing layer 18d are arranged in such a way that the polarization axes of them are perpendicular to each other. With regard to optical performances of both of the second polarizing layer 18b and the fourth polarizing layer 18d, the transmittance for unpolarized light is 43% (Y value) and the contrast is 8000, similarly to Embodiment 1 and Comparative Embodiment 1.

According to the present Embodiment, attributed to such polarizing layers, the transmittance of black state can be further reduced. That is, even if incident light which has been polarized by the second polarizing layer 18b is depolarized by the scattering factors in the TFT substrate 100, the first polarizing layer 18a increases the polarization degree of the light again. Such light with a high polarization degree can be caused to enter the liquid crystal layer 300. Further, the light which has been outputted from the liquid crystal layer can be selected by the third polarizing layer 18c before entering the scattering factors such as the color filter 21 in the counter substrate 200. Therefore, influences of the scattering factors in the counter substrate 200 on the contrast of the display device can be reduced. As a result, as shown in Table 1, the contrast of the display device in the present Embodiment was 17853 and the effect which was substantially 11.7 times higher than that in Comparative Embodiment 1 could be obtained.

### Embodiment 3

FIG. 5 is a cross-sectional view schematically showing a liquid crystal display device in accordance with Embodiment 3 of the present invention.

The liquid crystal display device in the present Embodiment is the same as in Embodiment 1, except that the color filter 21 is arranged not in the counter substrate 200 but in the TFT substrate 100, as shown in FIG. 5. Specifically, the respective bus lines and TFTs 8 are prepared and a color filter material is formed by patterning in each display region. Then, only a part just above a drain electrode part is provided with a contact hole. Then, a transparent conductive material which forms the pixel electrode 9 is formed by patterning. As a result, a structure in which the drain electrode part in the TFT 8 and the pixel electrode 9 have the same electrical potential is formed. Then, the first polarizing layer 18a and the alignment film 13 are formed on the pixel electrode 9. With regard to optical performances of the first polarizing layer 18a, the transmittance for unpolarized light is 45% (Y value) and the contrast is 100. The polarization axis of the first polarizing layer 18a is parallel to that of the second polarizing layer 18b attached on the lower side (on the rear face side). Similarly in Comparative Embodiment 1, the fourth polarizing layer 18d is arranged in the counter substrate 200. As a result, as shown in Table 1, the display device in the present Embodiment had a contrast of 8464, which was substantially 5.5 times higher than that in Comparative Embodiment 1.

### Comparative Embodiment 2

FIG. 6 is a cross-sectional view schematically showing a liquid crystal display device in accordance with Comparative Embodiment 2.

As shown in FIG. 6, the liquid crystal display device in the present Comparative Embodiment has the same structure as in Embodiment 1, except that the first polarizing layer 18a is not arranged in the TFT substrate 100, and the third polarizing layer 18c is arranged only in the counter substrate 200, thereby compensating the depolarization property of the color filter 21. As a result, the display device in accordance with the present Comparative Embodiment had a contrast of 2120, as shown in Table 1.

This shows that according to the liquid crystal display device in accordance with Embodiment 1, a high contrast effect that is substantially 2.0 times higher than that in the liquid crystal display device according to Comparative Embodiment 2 can be obtained. This must be because the scattering degree of the scattering factors in the TFT substrate 10, which is compensated in Embodiment 1, is larger than the scattering degree of the scattering factors in the Counter substrate 200, which is compensated in Comparative Embodiment 2. Accordingly, the high contrast effect is largely exhibited when the scatterings due to the scattering factors existing in the panel are more compensated.

### Embodiment 4

FIG. 7 is a cross-sectional view schematically showing a liquid crystal display device in accordance with Embodiment 4 of the present invention.

The liquid crystal display device in the present Embodiment is in accordance with a modified embodiment of Embodiment 1 (FIG. 1). It is important in the configuration in Embodiment 1 that the first polarizing layer 18a is arranged between the liquid crystal layer 300 and the scattering factors in the TFT substrate 100. According to the present Embodiment, as shown in FIG. 7, the pixel electrode 9 in the TFT substrate 100 is not provided with the slit part 9a, and the pixel electrode 9 has no or very low depolarization property (in the present Embodiment, the scattering degree of the pixel electrode 9 is less than 0.001%). Therefore, the first polarizing layer 18a is arranged between the pixel electrode 9 and the TFT 8. According to this, the first polarizing layer 18a is arranged on the rear face side of the pixel electrode 9. Therefore, the device can be driven at a lower voltage in comparison to an embodiment in which the polarizing layer is arranged on the pixel electrode 9. Due to the first polarizing layer 18a, the depolarization property of the TFT8 the source bus line 6, and the like, can be compensated. Further, the pixel electrode 9 has no or very low depolarization property, which is not compensated by the first polarizing layer 18a. As a result, the contrast of the display device can be improved.

### Embodiment 5

FIG. 8 is a cross-sectional view schematically showing a liquid crystal display device in accordance with Embodiment 5 of the present invention.

The liquid crystal display device in the present Embodiment is in accordance with a modified example of Embodiment 1 (FIG. 1). In some display modes, the dielectric structure 15 which is called rib, rivet, and the like, and which provides the rear face-side surface of the liquid crystal layer with an irregularity needs to be arranged. These structures possibly have a phase difference or scattering property. In the present Embodiment, the dielectric structure 15 is arranged on the liquid crystal layer 300 side of the pixel electrode 9. Therefore, as shown in FIG. 8, the first polarizing layer 18a is arranged between the dielectric structure 15 and the liquid crystal layer 300. According to this, the first polarizing layer 18a can compensate the depolarization due to the dielectric structure 15. As a result, the contrast of the display device can be improved.

### Embodiment 6

FIG. 9 is a cross-sectional view schematically showing a liquid crystal display device in accordance with Embodiment 6.

The liquid crystal display device in the present Embodiment is in accordance with a modified embodiment of Embodiment 1 (FIG. 1). According to the present Embodiment, as shown in FIG. 9, the patterning was performed to form a structure in which the first polarizing layer 18a is stacked only on edges (depolarization part) of the pixel electrode 9. According to this, the first polarizing layer 18a is partly formed only at a part which needs the polarization compensation on the pixel electrode 9. Therefore, the transmittance of white state can be increased. In addition, a voltage which is applied to the pixel electrode 9 can be applied to the liquid crystal layer 300, almost as it is. Therefore, the device can be driven at a lower voltage, in comparison to the embodiment in which the first polarizing layer 18a is arranged over the entire pixel electrode 9 surface.

FIGS. 10(a) to 10(d) are cross-sectional views schematically showing one example of a method of pattern-forming a polarizing layer on a substrate.

As shown in FIG. 10(a), a polarizing layer 31 is formed on a substrate 30, first. As shown in FIG. 10(b), a positive resist is uniformly applied with a spin coater or a slit coater, thereby applying a resist 32. Then, as shown in FIG. 10(c), an alkaline developer (TMAH (tetramethylammonium hydroxide)) is used to perform shower development, and thereby the resist 32 is patterned and simultaneously the water-soluble polarizing layer 31 is patterned. Then, under high vacuum and argon gas atmosphere, an alternative current high voltage is applied to decompose and evaporate the resin through such a dry-etching process. As a result, the polarizing layer 31 is pattern-formed on the substrate 30, as shown in FIG. 10(d). The method of pattern-forming the polarizing layer is not especially limited.

### Embodiment 7

FIG. 11 is a cross-sectional view schematically showing a liquid crystal display device in accordance with Embodiment 7 of the present invention.

The liquid crystal display device in the present Embodiment is in accordance with a modified embodiment of Embodiment 1 (FIG. 1). According to the present Embodiment, a protection layer 19 is stacked on the first polarizing layer 18a, as shown in FIG. 11. According to this, elution of ionic substances which might exist inside the first polarizing layer la into the liquid crystal layer 300 can be prevented, which can increase the reliability. As a method of forming the protection layer 19, a method in which a solution of a thermosetting monomer is applied by a slit coat method, and then polymerized by evaporating the solvent by heat.

### Embodiment 8

FIG. 12 is a cross-sectional view schematically showing a liquid crystal display device in accordance with Embodiment 8 of the present invention.

The liquid crystal display device in the present Embodiment is in accordance with a modified embodiment of Embodiment 2 (FIG. 4). According to Embodiment 2, it is important that the first polarizing layer 18a is arranged between the liquid crystal layer 300 and the scattering factors in the TFT substrate 100, and that the third polarizing layer 18c is interposed between the liquid crystal layer 300 and the scattering factors in the counter substrate 200. According to the present Embodiment, as shown in FIG. 12, the common electrode 22 in the counter substrate 200 is provided with a slit part 22a, and the common electrode 22 has a high depolarization property. Therefore, the third polarizing layer 18c is arranged between the common electrode 22 and the liquid crystal layer 300. According to this, influences of the common electrode 22 on the contrast of the display device can be reduced.

### Embodiment 9

FIG. 13 is a cross-sectional view schematically showing a liquid crystal display device in accordance with Embodiment 9 of the present invention.

The liquid crystal display device in the present Embodiment is in accordance with a modified embodiment of Embodiment 2 (FIG. 4). According to the present Embodiment, the dielectric structure 25 which is called rib, rivet, and the like, and which provides the front face-side surface of the liquid crystal layer 300 with an irregularity is arranged on the liquid crystal layer 300 side of the common electrode 22. According to this, influences of the dielectric structure 25 on the contrast of the display device can be reduced.

### Embodiment 10

FIG. 14 is a cross-sectional view schematically showing a liquid crystal display device in accordance with Embodiment 10 of the present invention.

The liquid crystal display device in the present Embodiment is in accordance with a modified embodiment of Embodiment 8 (FIG. 12). According to the present Embodiment, as shown in FIG. 14, the patterning is performed to form a structure in which the first polarizing layer 18a is stacked only on the slit part (depolarization part) 9a of the pixel electrode 9 and the third polarizing layer 18c is stacked only on the slit part (depolarization part) 22a of the common electrode 22. According to this, the first polarizing layer 18a is partly formed only at a part which needs the polarization compensation on the pixel electrode 9. Further, the third polarizing layer 18c is partly formed only at a part which needs the polarization compensation on the common electrode 22. Therefore, the transmittance of white state can be increased. In addition, a voltage which is applied to the pixel electrode 9 and the common electrode 22 can be applied to the liquid crystal layer 300, almost as it is. Therefore, the device can be driven at a lower voltage, in comparison to the embodiment in which the first polarizing layer 18a is arranged over the entire pixel electrode 9 surface and the third polarizing layer 18c is arranged over the entire common electrode 22 surface.

### Embodiment 11

FIG. 15 is a cross-sectional view schematically showing a liquid crystal display device in accordance with Embodiment 11 of the present invention.

The liquid crystal layer in the present embodiment is in accordance with a modified embodiment of Embodiment 3 (FIG. 5). According to the configuration in Embodiment 3, it is important that the first polarizing layer is interposed between the liquid crystal layer and the scattering factors in the substrate where the TFTs and the color filter are arranged. According to the present Embodiment, for example, the pixel electrode 9 in the TFT substrate 100 is not provided with the slit part 9a, as shown in FIG. 15. Therefore, the pixel electrode 9 has no or very low depolarization property (in the present Embodiment, the scattering degree of the pixel electrode 9 is less than 0.001%). Accordingly, the first polarizing layer 18a is arranged between the pixel electrode 9 and the TFT 8. According to the present embodiment, the first polarizing layer 18a can compensate the depolarization property of the TFT 8, the source bus line 6, and the like. Further, the pixel electrode 9 has no or very low depolarization property, which is not compensated by the first polarizing layer 18a. As a result, the contrast of the display device can be improved. Further, the first polarizing layer 18a is arranged on the rear face side of the pixel electrode 97 and therefore the display device can be driven at a low voltage in comparison to the embodiment in which the polarizing layer is arranged on the pixel electrode 9.

### Embodiment 12

FIG. 16 is a cross-sectional view schematically showing a liquid crystal display device in accordance with Embodiment 12 of the present invention.

The liquid crystal display device in the present Embodiment is in accordance with a modified embodiment of Embodiment 3 (FIG. 5). According to the present Embodiment, as shown in FIG. 16, the dielectric structure 15 which provides the rear face-side surface of the liquid crystal layer 300 with an irregularity is arranged on the liquid crystal layer 300 side of the pixel electrode 9. Therefore, the first polarizing layer 18a is arranged between the dielectric structure 15 and the liquid crystal layer 300. According to this, the first polarizing layer 18a can compensate the depolarization due to the dielectric structure 15. As a result, the contrast of the display device can be improved.

### Embodiment 13

FIG. 17 is a cross-sectional view schematically showing a liquid crystal display device in accordance with Embodiment 13 of the present invention.

The liquid crystal display device in accordance with the present Embodiment is in accordance with a modified embodiment in Embodiment 3 (FIG. 5). According to the present Embodiment, as shown in FIG. 17, the patterning is performed to form a structure in which the first polarizing layer 18a is stacked only on the edge parts (depolarization parts) 9a of the pixel electrode 9. According to this, the first polarizing layer 18a is partly arranged only at apart which needs the polarization compensation on the pixel electrode 9. Therefore, the transmittance of white state can be increased. Further, a voltage which is applied to the pixel electrode 9 can be applied to the liquid crystal layer 300, almost as it is. Therefore, the device can be driven at a lower voltage, in comparison to the embodiment in which the first polarizing layer 18a is arranged over the entire pixel electrode 9 surface.

In the present description, the terms “or more” and “or less” mean that the value described (boundary value) is included.

The present application claims priority under the Paris Convention and the domestic law in the country to be entered into national phase on Patent Application No. 2006-154959 filed in Japan on Jun. 2, 2006, the entire contents of which are hereby incorporated by reference.

### BRIEF DESCRIPTION OF DRAWINGS

FIG. 1 is a cross-sectional view schematically showing the liquid crystal display device in accordance with Embodiment 1 of the present invention.

FIG. 2 is a schematic view showing the method of measuring a scattering degree of a scatterer.

FIG. 3 is a cross-sectional view schematically showing the liquid crystal display device in accordance with Comparative Embodiment 1. FIG. 3 is also a schematic cross-sectional view taken along line A-B in FIG. 18.

FIG. 4 is a cross-sectional view schematically showing the liquid crystal display device in accordance with Embodiment 2 of the present invention.

FIG. 5 is a cross-sectional view schematically showing the liquid crystal display device in accordance with Embodiment 3 of the present invention.

FIG. 6 is a cross-sectional view schematically showing the liquid crystal display device in accordance with Comparative Embodiment 2.

FIG. 7 is a cross-sectional view schematically showing the liquid crystal display device in accordance with Embodiment 4 of the present invention.

FIG. 8 is a cross-sectional view schematically showing the liquid crystal display device in accordance with Embodiment 5 of the present invention.

FIG. 9 is a cross-sectional view schematically showing the liquid crystal display device in accordance with Embodiment 6 of the present invention.

FIGS. 10(a) to 10(d) are cross-sectional views schematically showing one example of the method of pattern-forming a polarizing layer on a substrate.

FIG. 11 is a cross-sectional view schematically showing the liquid crystal display device in accordance with Embodiment 7 of the present invention.

FIG. 12 is a cross-sectional view schematically showing the liquid crystal display device in accordance with Embodiment 8 of the present invention.

FIG. 13 is a cross-sectional view schematically showing the liquid crystal display device in accordance with Embodiment 9 of the present invention.

FIG. 14 is a cross-sectional view schematically showing the liquid crystal display device in accordance with Embodiment 10 of the present invention.

FIG. 15 is a cross-sectional view schematically showing the liquid crystal display device in accordance with Embodiment 11 of the present invention.

FIG. 16 is a cross-sectional view schematically showing the liquid crystal display device in accordance with Embodiment 12 of the present invention.

FIG. 17 is a cross-sectional view schematically showing the liquid crystal display device in accordance with Embodiment 13 of the present invention.

FIG. 18 is a planar view schematically showing one pixel of a TFT array substrate constituting a conventional VA mode liquid crystal display device.

FIG. 19(a) is a planar view schematically showing one pixel of a TFT array substrate constituting a conventional IPS mode liquid crystal display device. FIG. 19(b) is a schematic cross-sectional view taken along line A-B in FIG. 19(a).

FIG. 20(a) is a planar view schematically showing one pixel of a TFT array substrate constituting a conventional Super-IPS mode liquid crystal display device. FIG. 20(b) is a schematic cross-sectional view taken along line A-B in FIG. 20(a).

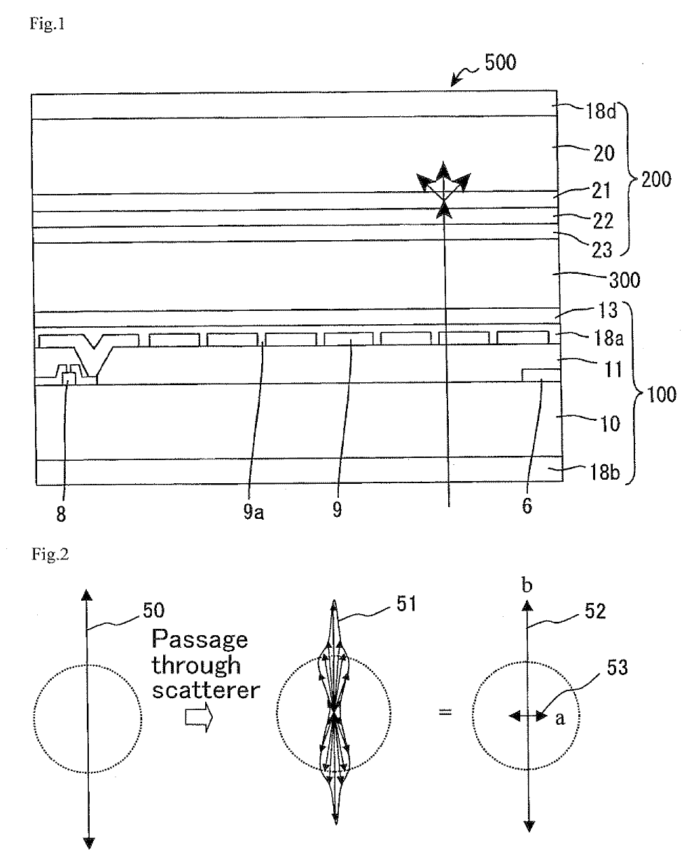

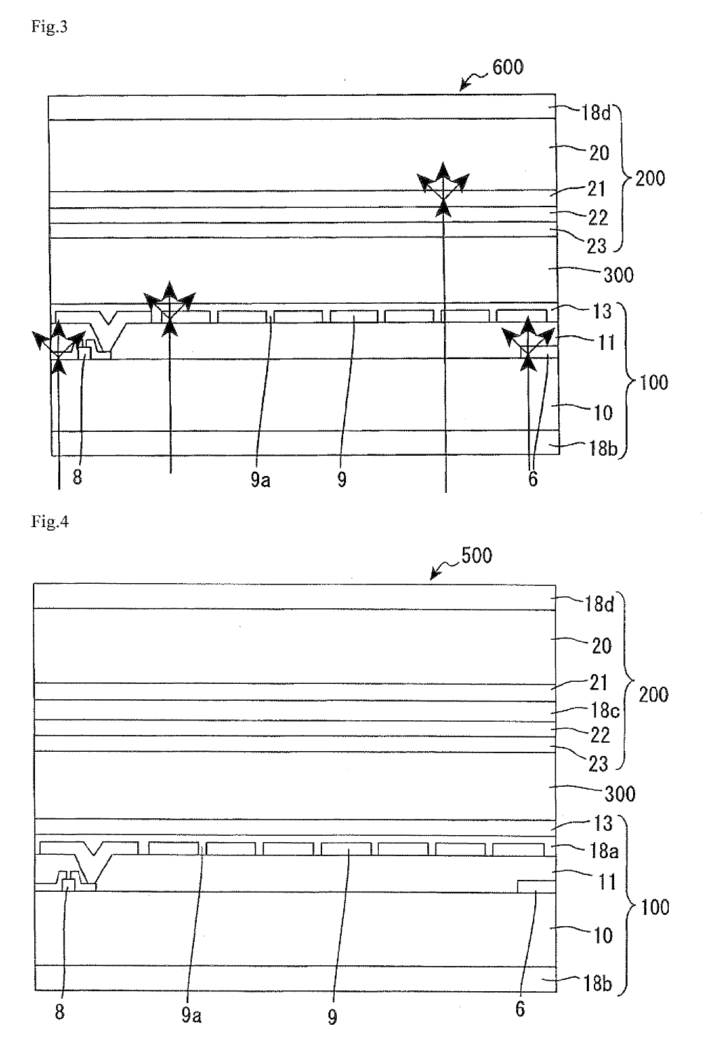

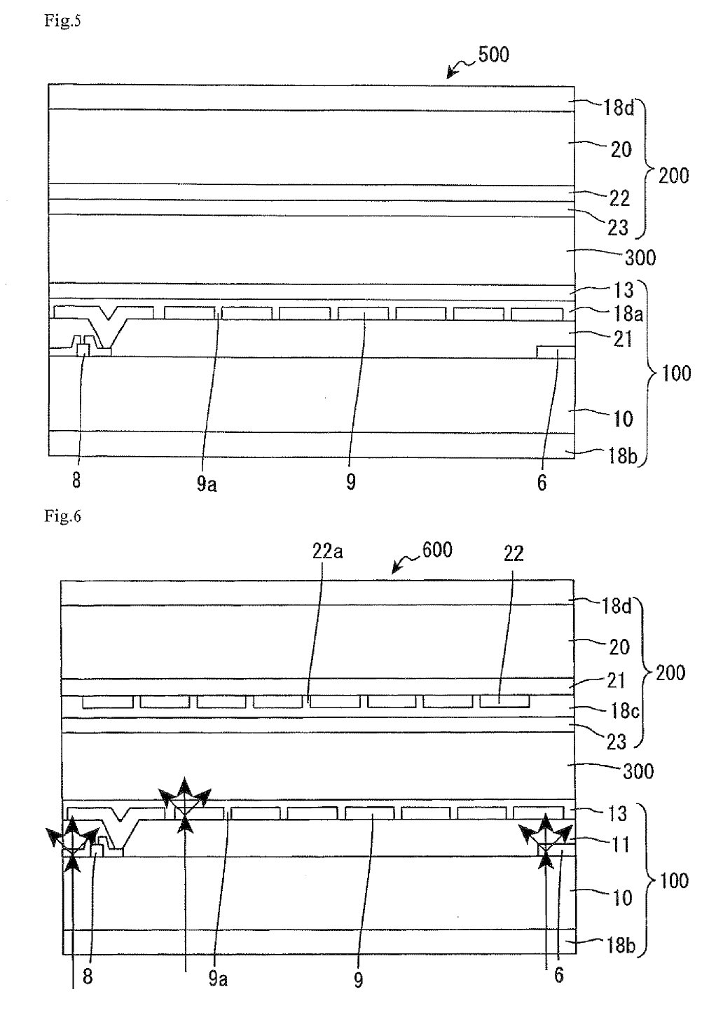

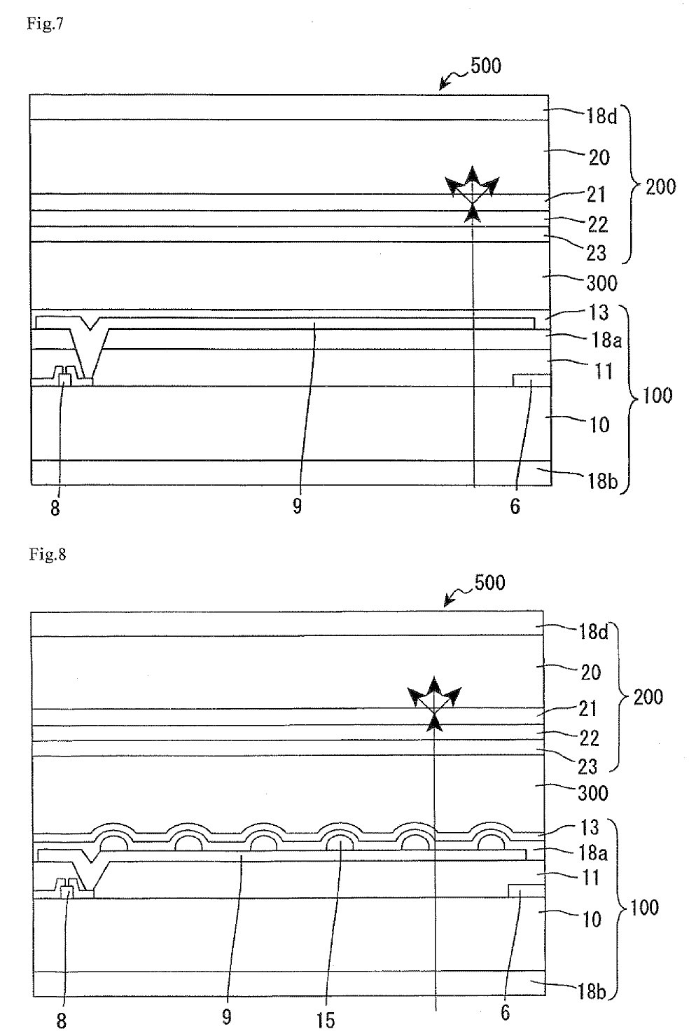

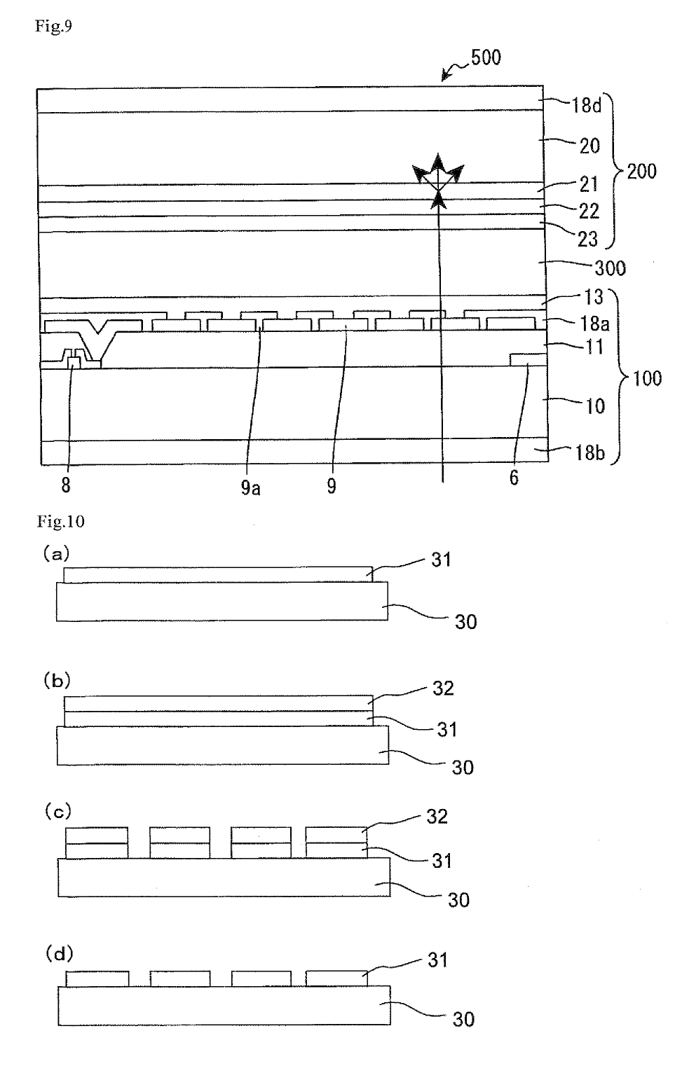

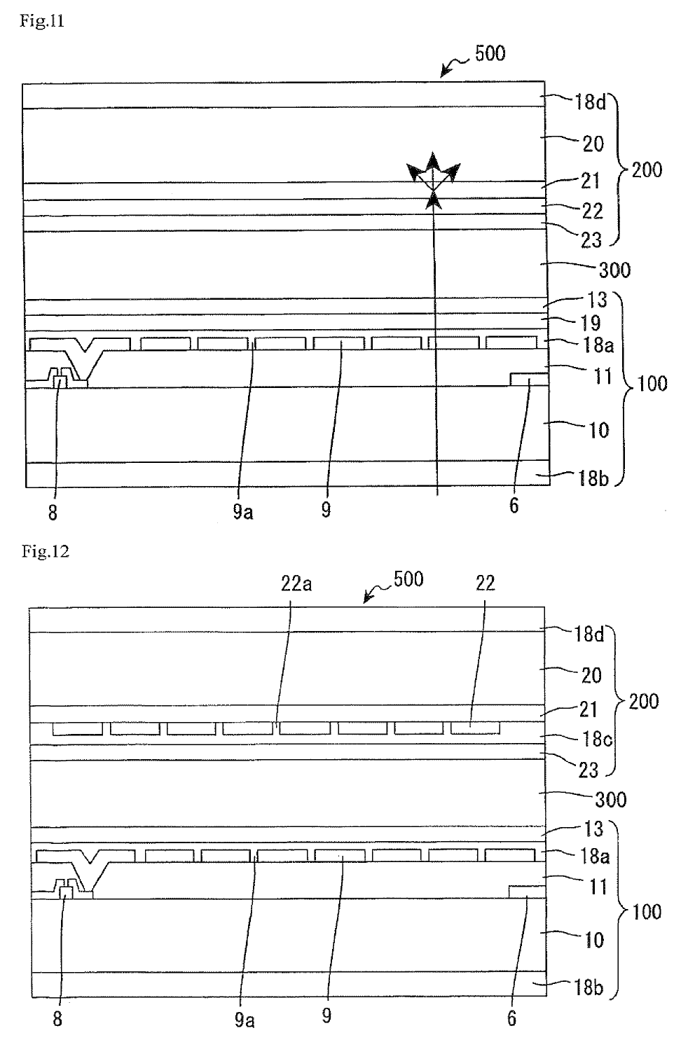

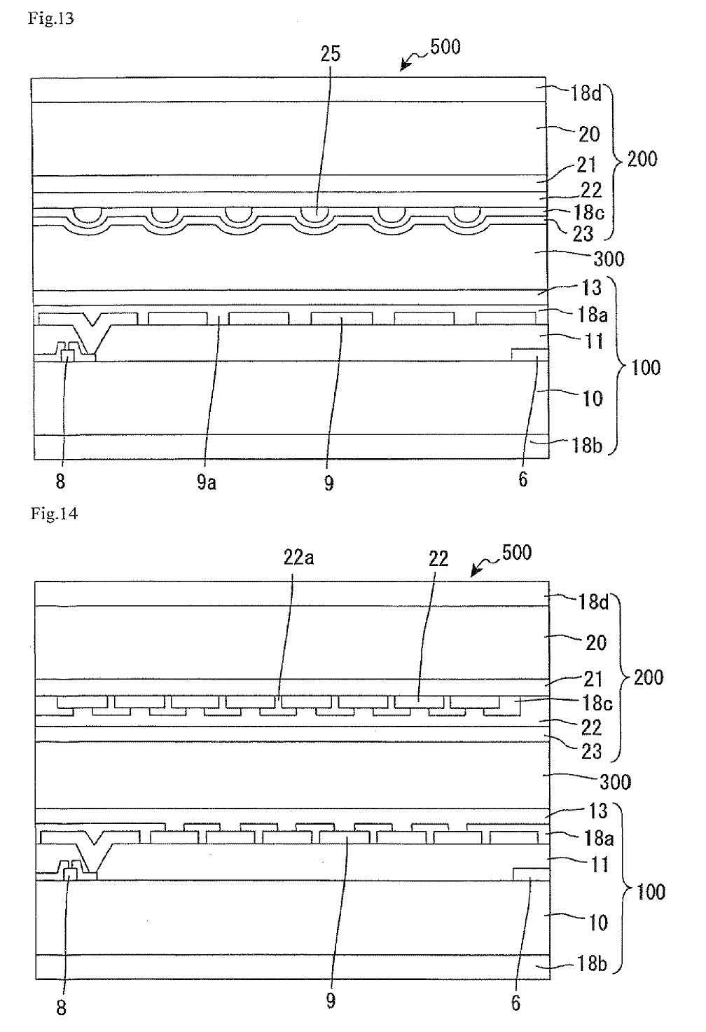

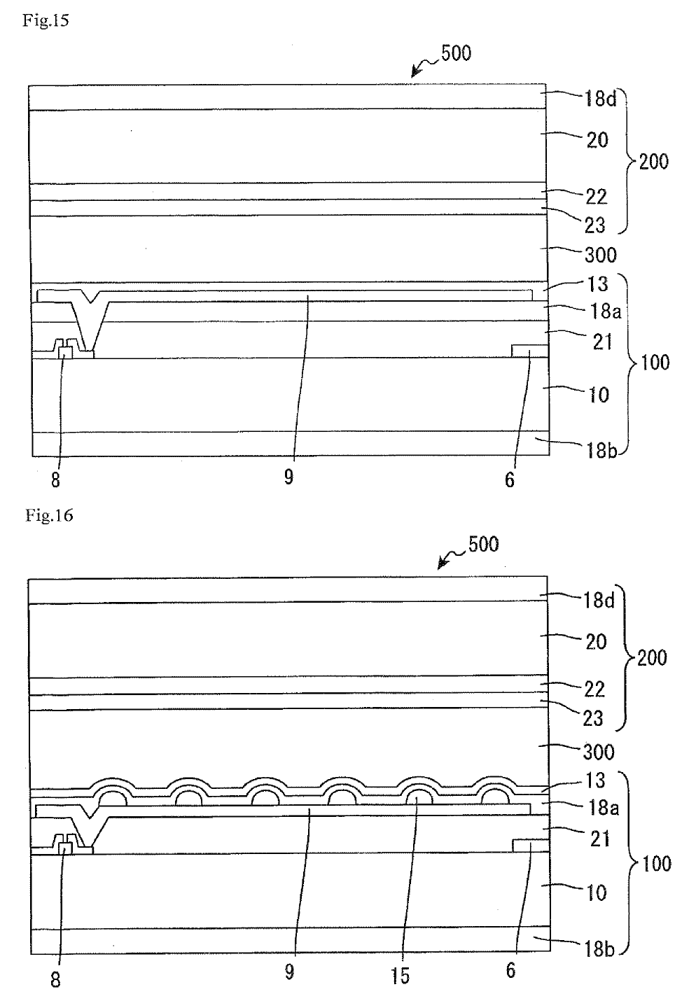

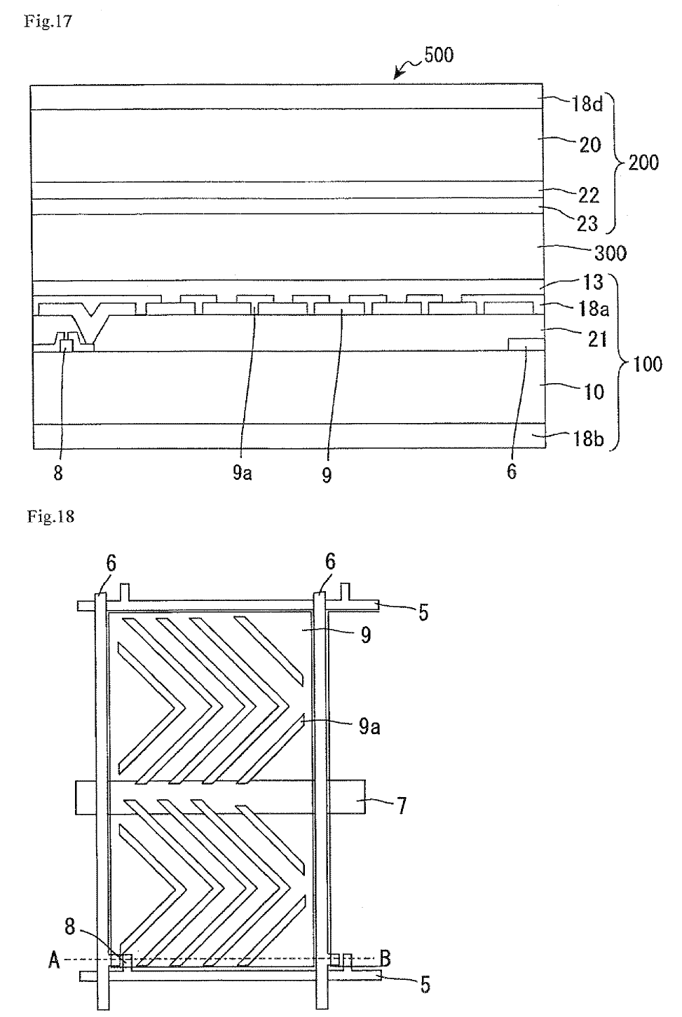

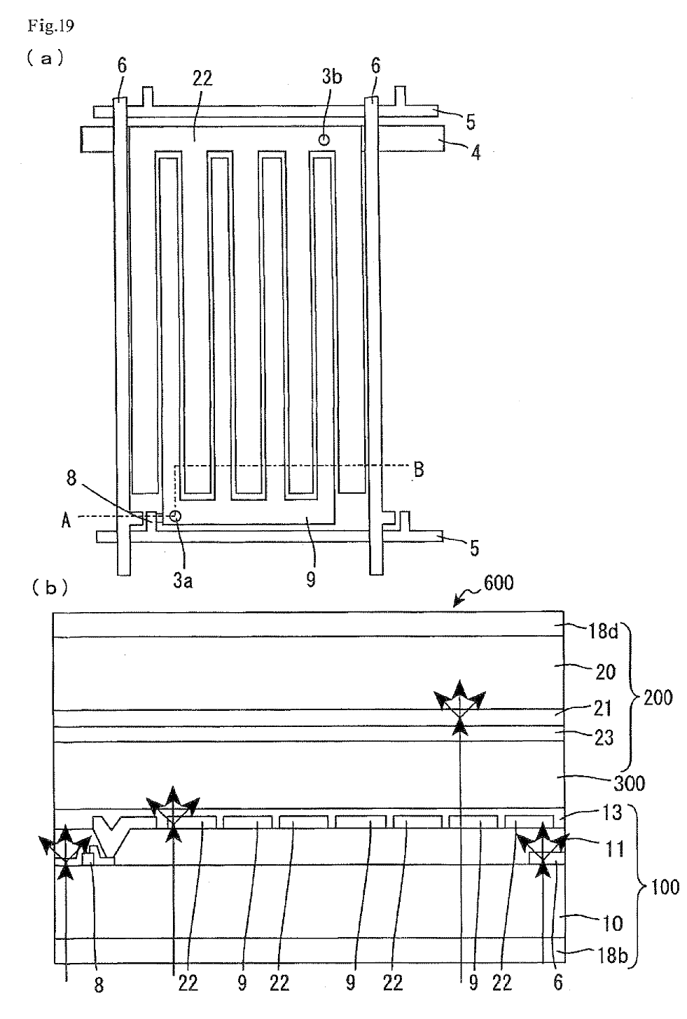

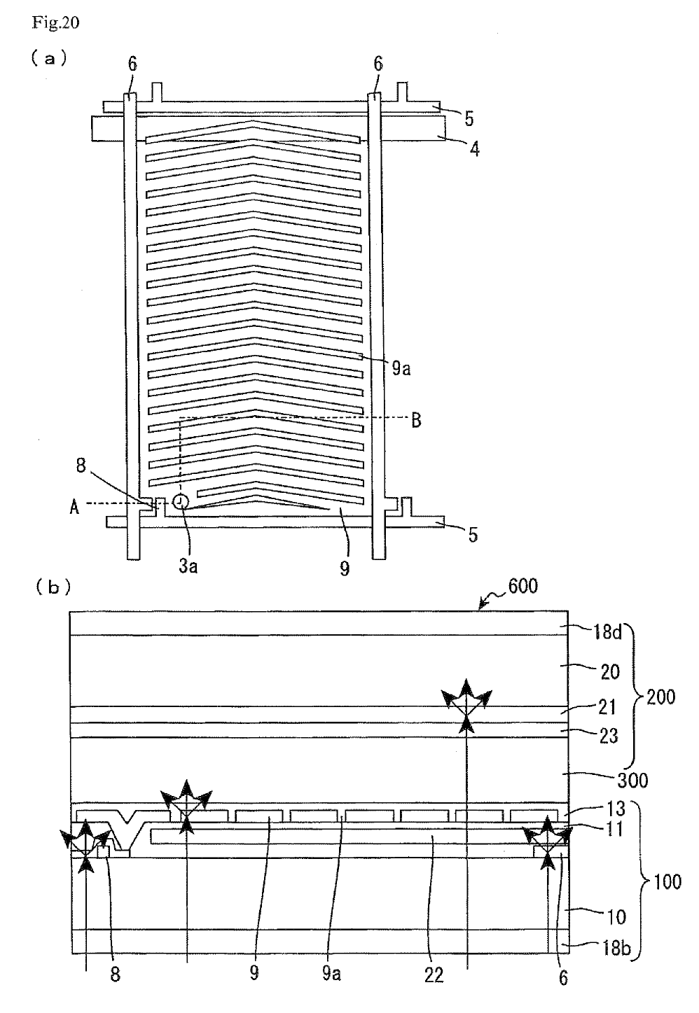

### EXPLANATION OF NUMERALS AND SYMBOLS

3a, 3b: Contact hole
4: Common wiring
5: Gate bus line (scanning line)
6: Source bus line (signal line)
7: Cs bus line
8: Thin film transistor (TFT)
9: Pixel electrode
9a: Slit part of pixel electrode 9
10: Glass substrate (rear substrate)
11: Resin layer
13, 23: Alignment film
15, 25: Rib (dielectric structure)
18a: The first polarizing layer
18b: The second polarizing layer
18c: The third polarizing layer
18d: The fourth polarizing layer
19: Protection layer
20: Glass substrate (front substrate)
21: Color filter
22: Common electrode
22a: Slit part of common electrode 22
30: Substrate
31: Polarizing layer
32: Resist
50: Completely polarized light
51: Light outputted from scatterer
52: Parallel component
53: Perpendicular component
100: TFT substrate
200: Counter substrate
300: Liquid crystal layer
500, 600: Liquid crystal display device

1. A liquid crystal display device having a structure in which a liquid crystal layer is interposed between a rear substrate and a front substrate,
wherein the liquid crystal display device includes a first polarizing layer between the rear substrate and the liquid crystal layer.

2. The liquid crystal display device according to claim 1,
wherein the liquid crystal display device includes a second polarizing layer on a rear face side of the rear substrate.

3. The liquid crystal display device according to claim 1,
wherein the liquid crystal display device includes a depolarization part between the rear substrate and the liquid crystal layer, and
the first polarizing layer is arranged between the depolarization part and the liquid crystal layer.

4. The liquid crystal display device according to claim 3,
wherein the depolarization part is at least one selected from the group consisting of a transistor, a wiring, a color filter, a pixel electrode, and a structure providing a rear face-side surface of the liquid crystal layer with an irregularity.

5. The liquid crystal display device according to claim 1,
wherein the liquid crystal display device includes a protection layer between the first polarizing layer and the liquid crystal layer.

6. The liquid crystal display device according to claim 1,
wherein the liquid crystal display device includes a pixel electrode between the rear substrate and the liquid crystal layer, and
the first polarizing layer is arranged on a rear face side of the pixel electrode.

7. The liquid crystal display device according to claim 3,
wherein the first polarizing layer is selectively arranged at the depolarization part.

8. The liquid crystal display device according to claim 1,
wherein the liquid crystal display device includes a third polarizing layer between the liquid crystal layer and the front substrate.

9. The liquid crystal display device according to claim 1,
wherein the liquid crystal display device includes a fourth polarizing layer on a front face side of the front substrate.

10. The liquid crystal display device according to claim 8,
wherein the liquid crystal display device includes a depolarization part between the liquid crystal layer and the front substrate, and
the third polarizing layer is arranged between the depolarization part and the liquid crystal layer.

11. The liquid crystal display device according to claim 10,
wherein the depolarization part is at least one selected from the group consisting of a color filter, a common electrode, and a structure which provides a front face-side surface of the liquid crystal layer with an irregularity.

12. The liquid crystal display device according to claim 8,
wherein the liquid crystal display device includes a protection layer between the third polarizing layer and the liquid crystal layer.

13. The liquid crystal display device according to claim 10,
wherein the third polarizing layer is selectively arranged at the depolarization part.
